(19) United States
(12) Patent Application Publication
(10) Pub. No.: US 2006/0133753 A1
(43) Pub. Date: Jun. 22, 2006

(54) Hole assisted fiber device and fiber preform

(76) Inventors: Brian K. Nelson, Shoreview, MN (US); Thomas M. Lynch, Woodbury, MN (US); Joseph A. Dyrda, Stacy, MN (US); James R. Onstott, Dresser, WI (US); Wayne F. Varner, Woodbury, MN (US)

Correspondence Address: 3M INNOVATIVE PROPERTIES COMPANY, PO BOX 33427, ST. PAUL, MN, 55133-3427, US

(21) Appl. No.: 11/021,138

(22) Filed: Dec. 22, 2004

(51) Int. Cl. G02B 6/032

(52) U.S. Cl. 385/125

(57) ABSTRACT

A hole-assisted fiber comprises a core region and a cladding region, where the cladding region includes multiple substantially elliptical holes spaced apart from each other to surround the core region. The holes are filled with one of a gas and a liquid to form a low refractive index portion of the cladding region.

### CROSS-REFERENCE TO RELATED APPLICATION

This application is related to US patent application entitled “Method of Making a Hole Assisted Fiber Device and Fiber Preform”, Attorney Docket No. 60129US003, filed on even date herewith, the disclosure of which is incorporated by reference herein in its entirety.

### BACKGROUND OF THE INVENTION

1. Field of the Invention

The present invention is directed to a hole-assisted optical fiber device.

2. Related Art

Optical fibers are used to transport telecommunications data all over the world. Conventional optical fibers are glass-based filaments that include a core region surrounded concentrically by one or more cladding layers having appropriate indices of refraction to confine the transported light by total internal reflection. The outer cladding layer likewise is surrounded by an external medium, such as a buffer material. The optical fiber can be designed to support one guided mode of propagation (i.e., a single mode fiber) or multiple guided modes of propagation (i.e., a multi-mode fiber).

Due to some inherent physical limitations of the conventional fiber design in terms of power capacity and bend performance, other fiber designs have been investigated. For example, hollow core fibers (some of which are referred to as “holey fibers” or “photonic crystal” fibers) have been manufactured. See e.g., A. J. Antos, “Back to the Future? Guiding Light Through Air,” Coming Optical Fiber Publication, Spring 2004. Other specialized types of optical fiber designs that have received recent interest include micro-structured optical fibers, as described in, e.g., U.S. Pat. No. 6,526,209 and U.S. Pat. No. 5,802,236, and photonic crystal or photonic band gap optical fibers, as described in, e.g., U.S. Pat. No. 6,334,019.

Conventional methods of making these types of holey fibers, micro-structured fibers, or photonic crystal fibers include using stacked arrays of cylindrical tubing or capillaries and/or drilling longitudinal holes or bores into a fiber preform. However, these techniques create problems with cleanliness, hole roughness, strength, high attenuation, and control of the hole size during the fiber draw. In addition, the manufacturing costs can be very high.

### SUMMARY OF THE INVENTION

According to a first aspect of the present invention, a hole-assisted fiber comprises a core region and a cladding region, where the cladding region includes multiple substantially elliptical holes spaced apart from each other to surround the core region. The holes can be filled with a gas or liquid having an index of refraction less than that of the cladding glass.

In another aspect of the present invention, a fiber preform comprises a core region and a cladding region, wherein the cladding region includes a plurality of slots formed in a perimeter thereof, extending depthwise in a radial direction towards the core region, and spaced apart from each other to surround the core region.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

The present invention will be further described with reference to the accompanying drawings, wherein:

FIG. 1A shows a cross sectional view of a hole assisted fiber according to an exemplary embodiment.

FIG. 1B shows a cross sectional view of a hole assisted fiber according to another exemplary embodiment.

FIG. 2 shows an example finite element modeling analysis of the cross section of a hole assisted fiber depicting the electric field lines of the propagating mode.

FIGS. 3A and 3B show sequential fiber preforms that are formed during a manufacturing process according to another exemplary embodiment.

FIGS. 4A-4D show different hole shapes and sizes for four fibers drawn under different applied pressures.

FIG. 5 shows a cross section view of another example hole-assisted optical fiber.

FIGS. 6A-6D show cross section views of other example hole-assisted optical fibers.

FIG. 7 shows the results of a bend performance experiment comparing the hole-assisted fibers of FIG. 6A-6D to a comparative sample single mode fiber.

FIGS. 8A-8C show images of three different hole assisted fibers that were drawn in accordance with the fabrication method according to another exemplary aspect of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE EMBODIMENTS

The present invention is directed to a hole-assisted optical fiber device. The hole-assisted fibers of the present invention can provide single mode operation over a wide bandwidth and as well as multimode operation. The hole assisted fibers provide greater bend tolerance due to the low refractive index surrounding the core. The hole assisted fibers can further provide high dispersion for dispersion compensation applications.

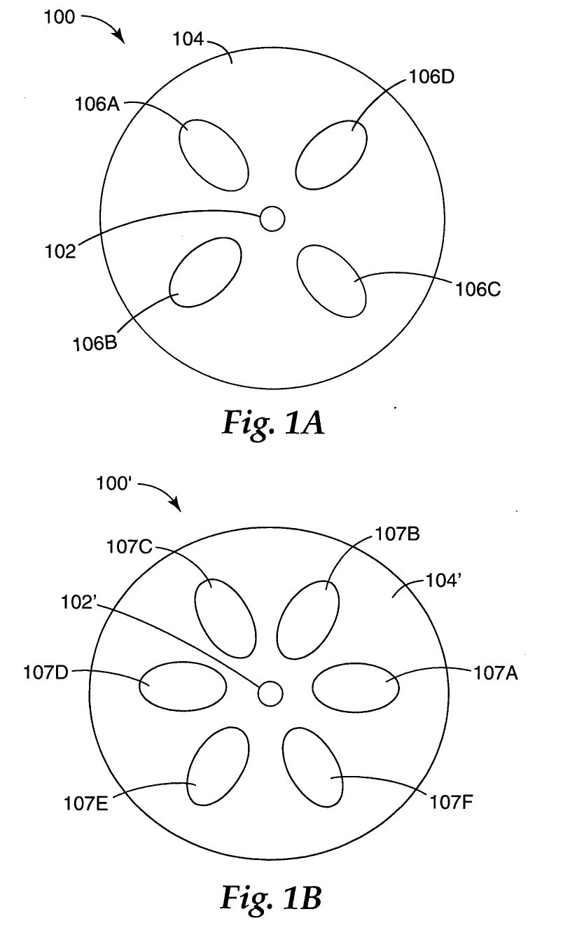

FIG. 1A shows a cross section view of first embodiment of the present invention, a “hole-assisted” optical fiber 100. Fiber 100 comprises a core (or core region) 102 and a cladding (or cladding region) 104. The core 102 and the cladding region 104 are exemplarily constructed of glass material, but may also be constructed of any suitable material. For example, the core 102 can comprise a silica material, doped (to modify the index of refraction) or undoped. The cladding region 104 can comprise a single cladding layer or multiple cladding layers. In addition, the cladding region 104 may be constructed from materials other than glass, such as fluoropolymers, fluoroelastomers, and silicones. Alternatively, core 102 can comprise a central rod of a higher refractive index material.

The core 102 can have a diameter suitable for a specific operation. For example, the diameter of core 102 can be from about 3 μm to about 15 μm (or slightly larger or smaller) if single mode operation is desired. The diameter of core 102 can be larger for intended multi-mode operation. In addition, the outer diameter of cladding region 104 can be any size, e.g. about 125 μm (corresponding to the size of standard telecommunications fibers), less than 125 μm, or greater than 125 μm, depending on the application.

In addition, optical fiber 100 can comprise one or more coatings (not shown for simplicity) surrounding cladding region 104. For example, one or more conventional buffer coatings can longitudinally enclose optical fiber 100. Alternatively, a protective coating can surround the cladding region 104. An exemplary protective coating can include the polymer-based coating formulations disclosed in commonly-owned U.S. Pat. No. 6,587,628. These materials are generally coatings for glass-glass-polymer (i.e., GGP) fibers, which include UV-curable compositions cured with a photoinitiator such as an iodonium methide salt that does not hydrolyze to release HF or Fluoride ion, or an iodonium methide photoinitiator. These polymer-based protective coatings can be permanent (i.e., not stripped from the fiber during connectorization) and also provide protection for the glass surface from scratches and the moisture induced reduction in mechanical strength.

In accordance with an aspect of the present invention, cladding region 104 contains one or more holes surrounding the core. For example, as shown in FIG. 1A, four holes 106A-106D are disposed symmetrically around core 102 and extend longitudinally along the length of fiber 100, preferably, the entire length of fiber 100. In another example, as shown in the cross section view of FIG. 1B, six holes 107A-107F are disposed in cladding region 104′ symmetrically around core 102, and extending longitudinally along the length of fiber 100′. According to the present invention, any number of holes may surround core 102, preferably four or more. In addition, the holes can be symmetrically or asymmetrically disposed about core 102. As will be apparent given the present description, the size, shape, and spacing of the inner cladding holes can be varied, depending on the particular design requirements.

In a preferred aspect, the holes of the cladding region are spaced from the core at a distance sufficient to affect the mode properties of the propagating light wave as desired. For example, the holes can be spaced at a distance of about 10 μm to about 25 μm from the outer diameter of the core (as measured to the nearest edge of the hole).

In a preferred aspect, holes 106A-106D have a substantially elliptical shape in cross section. By “substantially elliptical,” it is meant that the holes are not required to form a perfect ellipse in cross section, as the inner portion of the hole(s) 106A-D (i.e., the portion of the hole nearest the core) can be wider than, the same width as, or narrower than the outer portion of the hole(s) 106A-D. In this aspect, the holes are non-circular in cross-section. The use of substantially elliptical holes, as opposed to circular holes, can provide a greater displacement of the cladding glass without having to add additional rings of holes.

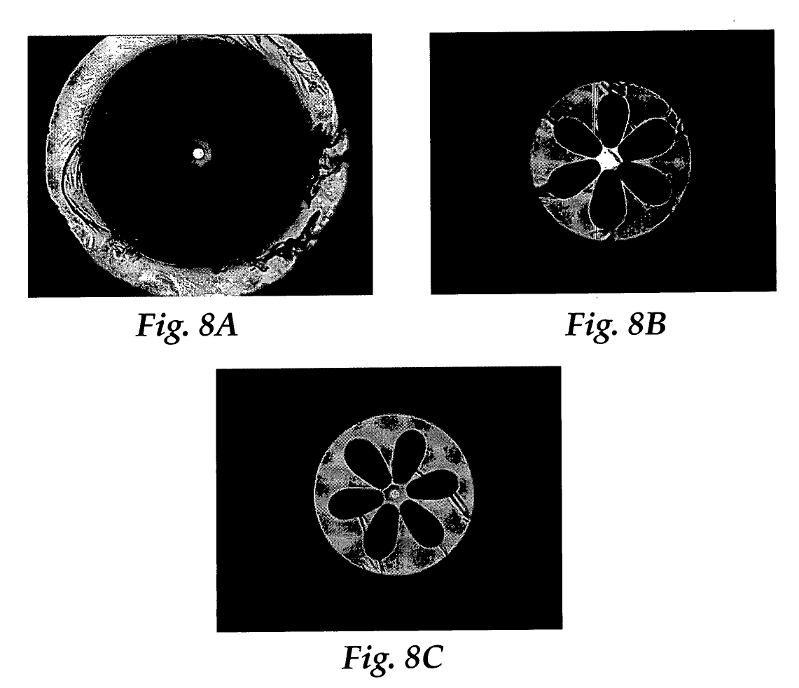

For example, FIGS. 8A-8C show images of three exemplary hole assisted fibers that were drawn in accordance with the fabrication method described in detail below. Each of these examples is illustrative of the substantially elliptical holes described herein. In addition, as shown in FIGS. 8A-8C, a large amount (of about 40% or more) of the cladding region can be replaced by an air-filled hole. This glass displacement permits a fiber designer to create a wide variety of different types of fibers. For example, the fiber shown in FIG. 8B is a multi-mode fiber having a large numerical aperture, while the fiber shown in FIG. 8C is capable of single mode operation. Each of these fibers also has the added benefits of improved bend performance due to the presence of the holes.

In alternative embodiments, the holes can be substantially circular in cross-section, or can form some other shape. As explained in detail below, in accordance with another embodiment of the present invention, the manufacturing process described herein permits a fiber manufacturer to specifically tailor the shape of the holes disposed in the cladding region for a particular desired result.

The one or more of the holes of the hole assisted fiber can be filled with a gas or liquid having a lower index of refraction than the surrounding cladding region. In a preferred aspect, the holes (106A-D or 107A-F) are filled with air to provide a low index of refraction (of about 1) for the individual hole regions. Alternatively, one or more of the holes are filled with a gas or liquid so that the hole assisted fiber can be used in sensing applications. For example, a liquid or gas containing a biological sample can be used to fill one or more of the holes 106A-D or 107A-F for biosensing applications.

In another example, for photosensitive applications (e.g., writing Bragg gratings), the holes may be temporarily or permanently filled with an ultraviolet, transparent, and/or index-matched fluid to avoid undesirable refractive effects from the holes. Suitable liquids are available from Cargille, Cedar Grove, N.J. In this example, the core can be can suitably doped, e.g., with GeO₂, or another dopant, to improve photosensitivity. A grating can be written onto the core region from the side of the fiber using a conventional holographic or phase mask technique. A photosensitive hole assisted fiber with a Bragg grating inscribed in it can be useful for, e.g., add/drop applications in telecommunications.

Other liquids or gasses can also be used to fill holes 106A-D or 107A-F, depending on the application.

In preferred aspects, the presence of one or more holes to surround a core or core region in optical fiber 100 can be used to create a low index cladding region surrounding the core. In addition, the disposition of one or more holes closer to or farther from the core region of fiber 100 can be tailored to match a selected propagating mode profile that is guided by fiber 100.

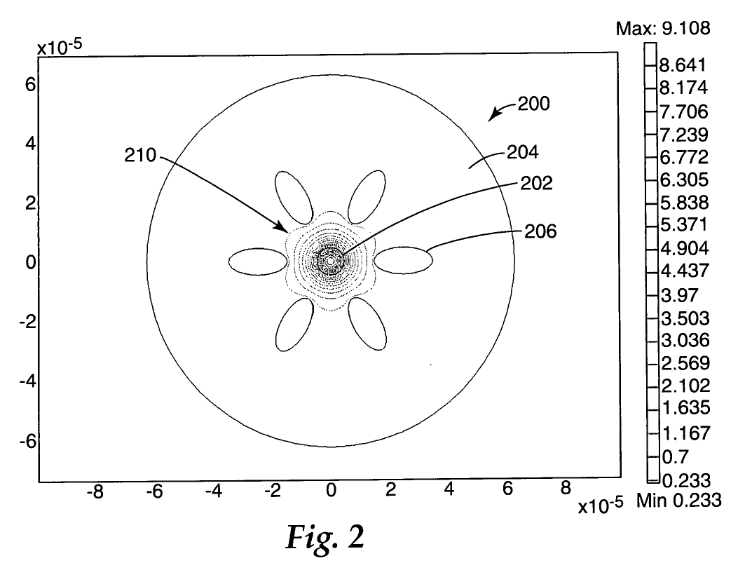

For example, FIG. 2 shows an example finite element modeling analysis of the cross section of a hole assisted fiber 200 comprising a core or core region 202 and a cladding region 204. As shown in FIG. 2, the cladding region includes six symmetrically disposed, substantially elliptical holes 206. In this example, the waveguide core 202 is about 9 μm in diameter, having an index of refraction of 1.44942 (corresponding to a silica core doped with GeO₂). The cladding region 204 comprises a silica material having an index of refraction of 1.44692 and an outer diameter of about 125 μm. Holes 206, which are filled with air in this model, have a major axis of about 20 μm and a minor axis of 9 μm. As is shown in FIG. 2, the inner edge of each hole 206 is spaced from the edge of the core by a distance of about 10.6 μm.

The finite element modeling analysis also shows the electric field (E-field) contour lines 210 of the confined waveguide mode about the core region. As the confined mode spreads out from the core region, the E-field lines become more distorted in the proximity of the holes (each having a much lower index of refraction than the silica cladding material). As the holes are moved closer to the core, the effective index of the cladding is reduced and the mode is more tightly confined leading to a smaller mode field diameter and reduced macrobending induced optical attenuation. As the investigators have determined, closer hole spacing to the core region can result in larger mode field distortion, while holes spaced farther from the core region can result in less distortion of the mode field.

As mentioned above, the manufacturing process described herein permits a fiber manufacturer to specifically tailor the shape of the holes disposed in the cladding region for a particular desired result. An exemplary manufacturing process for fabricating a hole-assisted fiber is summarized as follows.

First, a starting glass rod or starting preform is selected and/or fabricated. Next, one or more slots are radially cut into or ground into the starting preform from the perimeter of the starting preform towards the center of the preform. These slots can be formed along all or part of the length of the preform. Optionally, next, the ground or cut preform is cleaned. Following the optional cleaning procedure or grinding procedure, longitudinal or axial channels are defined by an overcollapse process, where a tube is overcollapsed onto the perimeter of the modified starting preform. Optionally, internal pressure is applied to the newly formed channels after the overcollapsing process to maintain a desired shape of the channel. Lastly, a fiber drawing process is performed on the overcollapsed preform. During the fiber draw, optionally, internal pressure can be applied to the fiber channels to form holes, such as holes 106A-D and 107A-F, described above, having a desired shape for a particular application.

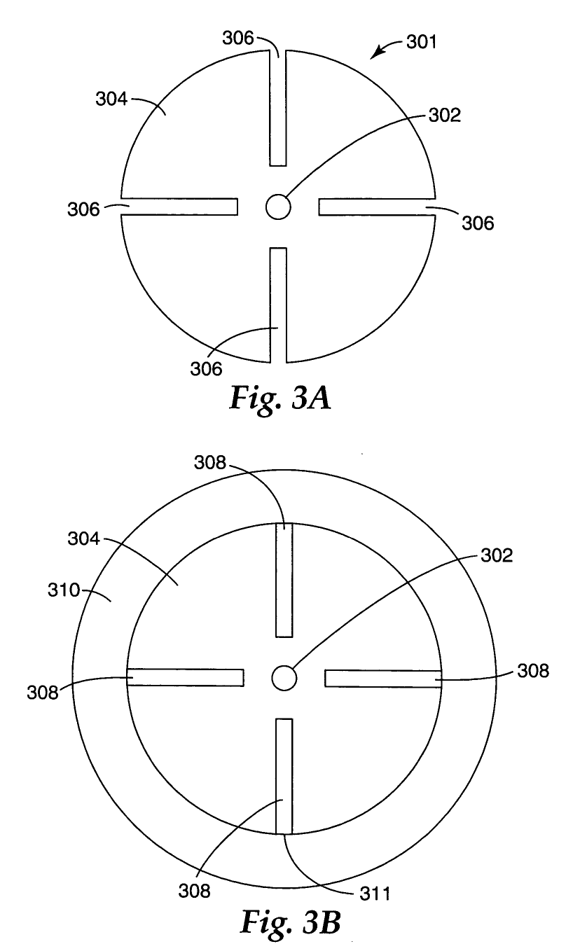

For example, an exemplary process of manufacturing a hole-assisted fiber can be described in more detail with reference to FIGS. 3A and 3B. As shown in cross-section view in FIG. 3A, an appropriate glass rod or starting preform 301 can be utilized. The starting rod or preform can be a conventional silica material, with a core 302 and/or cladding region 304 formed as deposited layers having higher and lower indices of refraction. The manufacturing process described herein allows the fiber manufacturer to utilize existing or conventional single mode and multimode preform constructions (having known refractive index profiles). For example, the starting preform 301 can be formed using, e.g., a conventional chemical vapor deposition process, such as MCVD or a conventional variant thereof. Other suitable starting preforms can include conventional quartz or silica bar materials. For example, an undoped silica rod, such as that available from Haraeus Tenero, Buford, GA, can be utilized.

After the starting rod or preform is prepared, one or more slots 306 (FIG. 3A shows four such slots) can be formed in the starting rod or preform 301. The slots are formed around the perimeter of the rod/preform at equal or unequal spacings and have a depth that extends radially towards the preform core region. For example, FIG. 3A shows for slots 306 equally spaced about a perimeter of preform 301. In a preferred aspect, a diamond cutting blade, e.g., such as a diamond coated grinding wheel, having a width of about 0.050″ to about 0.060″, or a similar conventional surface grinder apparatus, can be used to grind a slot from the outer surface of the glass preform 301 radially towards the center of the rod. The grinding process may include multiple passes along the length of the fiber preform. Depending upon the preferred design, multiple slots with depths of from 0.122″ to 0.17541 can be fabricated; however the depth can depend on parameters such as the preform diameter, the number of slots, and the slot width. In this respect, the starting preform 301 can be secured on an MCVD lathe, or similar platform, during the grinding/cutting process using, e.g., a conventional clamping mechanism.

In a preferred aspect, the slots are formed along the entire longitudinal or axial length of the preform or starting rod. Alternatively, the slots can be formed along a partial length of the starting rod or preform. The slots can be formed to a sufficient radial depth as desired, depending, for example, on the desired distance from an edge of the cladding hole to the core region of the fiber. In a preferred aspect, the depth of slot(s) 306 is maintained at the same depth along the entire length of the slot(s), such that the depth of each of the slots should be substantially equal around the core. The cutting depth can be controlled by conventional grinding techniques.

Optionally, in a preferred aspect, after slot grinding, an etching process can be utilized to further clean the preform 301 and slots 306. For example, an acid such as HF acid, or a similar acid, can be utilized to perform etching. Thus, the grinding technique, in addition to the etching process, can provide clean slot surfaces formed in the fiber preform, thereby removing particulate contamination from the ground or cut surfaces, which can result in result in a stronger fiber with lower attenuation, as compared to conventional drilling techniques. In addition, the grinding process described herein can be implemented in mass production techniques.

After slots 306 are formed to a desired radial depth, the slots are then captured or enclosed to form longitudinal or axial channels 308 (i.e., channels running parallel to the central axis or core 302 of the preform) that can have openings at either or both ends of the preform. For example, as shown in FIG. 3B, in a preferred aspect, the axial channels 308 can be formed by overcollapsing a glass/silica tubing 310, which thus defines a perimeter boundary 311 for the channels 308. In one exemplary aspect, the starting preform or rod 301 is secured on an MCVD lathe (or similar platform) and is overcollapsed by a fused silica tube in a conventional manner. As would be apparent to one of ordinary skill in the art given the present description, more than one overcollapse tube can also be used in the overcollapse process.

In an alternative aspect, the formation of multiple rings of holes can be utilized, e.g., for fabricating a photonic crystal-like fiber. For example, multiple rings can be formed by adding further slots (not shown) to the overcollapsed tube 310. Then, a second overcollapse process, using, e.g., a second overcollapse tube disposed about the perimeter of the first overcollapse tube 310, can be performed to capture these additional slots. According to exemplary embodiments of the present invention, any number of rings of holes can be created by repeating the grinding and over collapsing processes.

In addition, the overcollapse process is a non-contaminating process, resulting in a very clean interior surface for the fiber channels being formed. Precise location of the channels (and resulting holes) can be accomplished using simple fixturing. Using this process, very large diameter preforms can be fabricated in a straightforward manner, resulting in long, continuous fiber draws. By comparison, conventional capillary stacking techniques result in capillary type preforms that are usually the result of multiple draw downs, eventually yielding relatively short continuous lengths of the final fiber.

According to a preferred aspect of the present invention, the investigators have determined that the shape of the channels 308 can be maintained or altered to a desired shape by pressurizing the channels 308 after the overcollapsing process, prior to the fiber draw process. For example, after an overcollapse, the preform channels 308 can be pressurized by injecting a gas, e.g., air, Ar, N₂, or He, into the channels. This internal pressurization of the preform, prior to the fiber draw, is optional, in that hole-assisted fibers can be manufactured according to the above slot formation/overcollapsing techniques without pre-draw pressurization. However, the preform pressurization technique can be used to better maintain a desired hole structure.

For example, an appropriately sized gas line (depending on the outer diameter of the overcollapse tube) can be fitted over one end of the overcollapsed tube (which extends beyond the end of the preform) after the overcollapse process. Pressurized gas can be applied to the gas line, providing a flow of gas through the channels formed in the overcollapsed preform. A splitter or T-device coupled to a pressure valve, or other device, can be used to monitor and/or provide a constant or variable gas flow at a desired pressure. For example, FIGS. 8A-8C show cross section images of example fibers that were drawn from preforms that were pressurized prior to the fiber draw process.

This pressurization technique can be used to reduce the likelihood that the channels will collapse into themselves, as the preform is exposed to substantial heat during the manufacturing process. This pressurization process can also be utilized when fabricating a hole-assisted fiber having multiple rings of holes to prevent pre-collapse of those channels/holes during formation of the outer channels/holes. In addition, while the preform is being heated (e.g., by using a burner, torch, or similar apparatus) after an overcollapse, higher or lower internal pressures can be applied to the channels 308 to alter the shape and/or size of the channels. The heat and pressurization can also lead to smoother interior surfaces for the holes. As would be apparent to one of ordinary skill in the art given the present description, the channel/hole shape can be tailored by varying the application sequence and magnitude of factors such as pressure and heat. In a further preferred aspect, water and/or other contaminants can be removed by flowing, e.g., chlorine gas through the channels while the preform is heated and pressurized.

The overcollapsed preform is then drawn into a fiber. For example, the fiber can be drawn using a conventional draw tower apparatus. In addition, according to one exemplary aspect, to facilitate the cladding hole retention, it has been determined that applying internal pressure to the channels/holes during the draw process allows for relatively slow draw speeds (about 60 meters per minute or less) and relatively higher draw temperatures (about 2050° C.-about 2300° C.). As would be understood by one of ordinary skill in the art given the present description, parameters such as furnace temperature, preform pressure and drawspeed are interrelated and can be varied appropriately to yield a desired hole-assisted fiber.

As the investigators have determined, by varying the pressurization level, it is possible to change the size and shape of the holes and thereby control the light-guiding characteristics of the fiber. For example, a gas line can be fitted over an end of the preform and pressurized gas can be applied to the channels during the fiber draw, in a manner similar to that described above.

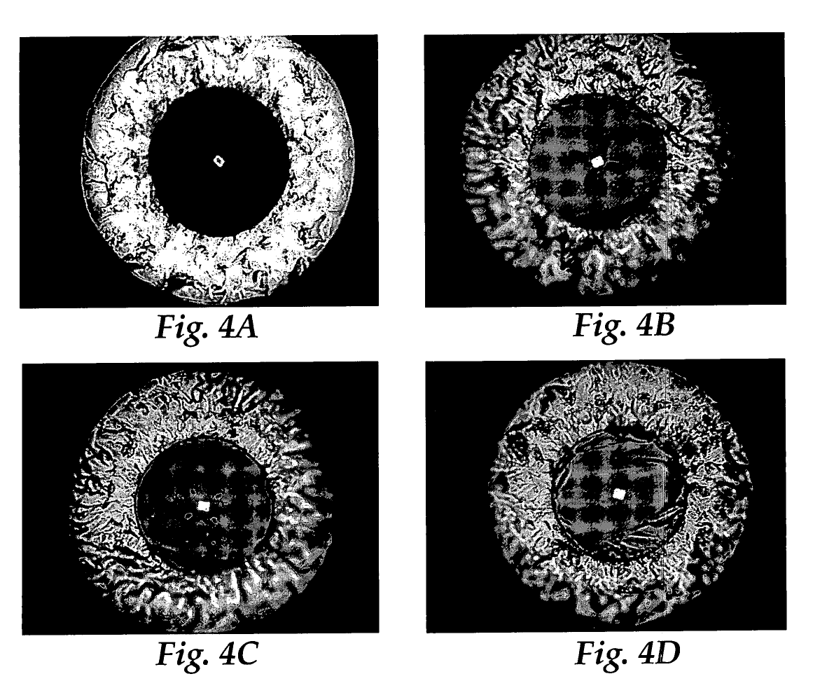

For example, FIGS. 4A-4D show cross-sectional images of four different hole assisted optical fibers having holes of different cross-sectional shapes and sizes. FIG. 4A shows a hole assisted fiber having four substantially elliptically shaped holes disposed in the fiber cladding region and symmetrically spaced about the core region. The holes of FIG. 4A were formed by applying pressurized N₂ gas to the holes, at a pressure of about 1.5 inches of water. As a comparison, FIG. 4B shows four substantially elliptically shaped holes disposed in the fiber cladding region and symmetrically spaced about the core region that were formed by applying pressurized N₂ gas to the holes, at a pressure of about 1.2 inches of water. The holes of FIG. 4B have a smaller cross-sectional area than the holes of FIG. 4A. As a further comparison, FIGS. 4C and 4D show four cladding holes, having progressively smaller cross sectional areas. The holes in FIG. 4C were formed by applying pressurized N₂ gas to the holes, at a pressure of about 0.6 inches of water and the holes of FIG. 4D were formed by applying pressurized N₂ gas to the holes, at a pressure of about 0.4 inches of water. Thus, a fiber manufacturer can tailor hole size and shape to match a specific hole assisted fiber design for a particular application.

In addition, pressurization of the holes during the fiber drawing process can be used to alter or modify the size of the core region and thus the modal properties of the fiber.

Alternatively, according to another aspect, fiber drawing can be accomplished using a relatively cold temperature (about 1900° C.-about 2100° C.), and a relatively fast drawing speed (about 90-about 300 meters/minute) to retain the general position and relative size of the holes in the fiber. Internal pressurization of the channels/holes can be optional using this temperature/draw speed technique.

After the fiber draw process is accomplished (or during the process, if the draw tower is appropriately equipped), the outside of the glass fiber can be coated with one or more of several coating materials including both thermal and ultraviolet curing materials as part of the drawing process or subsequent to the draw. The first coating layer may also be of the permanent, non-strippable type used for GGP fiber constructions, as described above. Of course, one or more conventional buffer coatings, such as described above, can be applied to the drawn fiber, as would be apparent to one of ordinary skill in the art given the present description.

### EXAMPLES

In a first example, a single mode preform was fabricated by conventional MCVD techniques. The finished diameter of the preform was 10.9 mm. Four slots of equal dimensions were ground into the preform by a conventional surface grinding machine and a conventional diamond impregnated grinding wheel. The grinding wheel thickness was 1.4 mm. During the grinding process, the preform was mechanically secured to the movable surface grinding table which was traversed continuously as the grinding wheel was slowly lowered to the specified slot depth (i.e., a conventional “plunge” grinding process). At the completion of the fabrication of one slot, the preform was rotated by 90 degrees and the process repreated to generate a second slot. This process was repeated until the desired four slots has been ground into the preform. The completed slots were about 1.4 mm wide and had a depth of about 4.5 mm.

The preform was chemically cleaned by conventional techniques. After cleaning, the preform was positioned in a conventional glassworking lathe. The lathe comprised a mechanism (holding clamp) to hold the preform and an overjacketing tube along the center of the lathe rotation, and a rotation mechanism to rotate the preform and overjacketing tube. A conventional oxyhydrogen torch whose temperature, position and traverse velocity could be controlled was fitted to the lathe carriage. For this example, the silica overjacketing tube had an outside diameter of 25 mm and an inside diameter of about 19 mm and was collapsed onto the subject preform by conventional techniques using the hydrogen torch. At the completion of the overcollapse procedure, the preform diameter was about 19.15 mm.

After the overcollapse process, the resulting preform was subjected to two additional heating passes. For both passes, the hydrogen torch speed was 26.8 mm/minute. For the first pass, the preform was heated to a temperature of 2214° C. and for the second pass, the temperature was increased to 2239° C. Temperatures were determined via conventional optical pyrometry. During both of the post overcollapse passes, a controlled pressure was applied to the preform slots. At the completion of this process, the preform diameter had been increased to about 20.3 mm.

After completion of the preform fabrication process, the preform was drawn into optical fiber using a conventional optical fiber drawtower. The draw furnace temperature was 2150° C., and the draw speed was 60 meters/minute. The diameter of the drawn fiber was 80 μm and the fiber was coated with a conventional UV acrylate material. The coated diameter of the fiber was ˜160 μm. During the draw process, a pressurization mechanism, similar to that described above, was provided to apply pressurized nitrogen to the channels within the preform. The pressure was controlled to 1.5″ water (fiber D4783), 1.2″ water (fiber D4784), 0.6″ water (fiber D4787) and 0.4″ water (fiber D4788) to produce four individual fibers, shown in cross section view in FIGS. 4A-4D, respectively. As is evident from microphotographs of the individual fibers shown in FIGS. 4A-4D, the hole size in the fibers decreased with decreasing fiber pressure. Each of the fibers was optically characterized for single mode operation (cutoff wavelength), mode field diameter and attenuation, using conventional fiber characterization equipment and standard measurement procedures. These results are summarized below in Table 1.

TABLE 1

| | Fiber Draw | Cutoff | | Attenuation |
|---|---|---|---|---|
| | Pressure | Wavelength | Mode field | (db/km) |
| Fiber ID | (in H₂O) | (nm) | Diameter (μm) | @1550 nm |
| D4783 | 1.5 | 1280 | 5.96 | 6.1 |
| D4784 | 1.2 | 1300 | 5.7 | 5.9 |
| D4787 | 0.6 | 1340 | 7.4 | 6.47 |
| D4788 | 0.4 | 1380 | 7.6 | 5.9 |

In another example, a starting preform was fabricated using a 13 mm diameter “214” G.E. quartz rod. Eight equally spaced slots (2 mm wide by 2 mm deep) were ground in the perimeter of the starting preform that extended the length of the starting preform. The slots were formed by using a 0.060″ diamond wheel with multiple passes performed to form each slot to the selected width and depth. The slotted rod was cleaned in an HF acid bath and then overcollapsed with a 17 mm by 21 mm quartz tube (G.E. “095” type) resulting in a rod with overall diameter of 17.2 mm and eight almost square-shaped holes. The outside of this preform was then re-ground with another set of eight 2 mm by 2 mm slots equally spaced between the inner set of eight holes. Again, this preform was cleaned in HF acid and overcollapsed with 22 mm by 25 mm quartz tube (G.E. “095” type) to a 20.0 mm outer diameter. An additional 30 mm by 34 mm tube was then added over this preform resulting in an outer diameter of 25.5 mm.

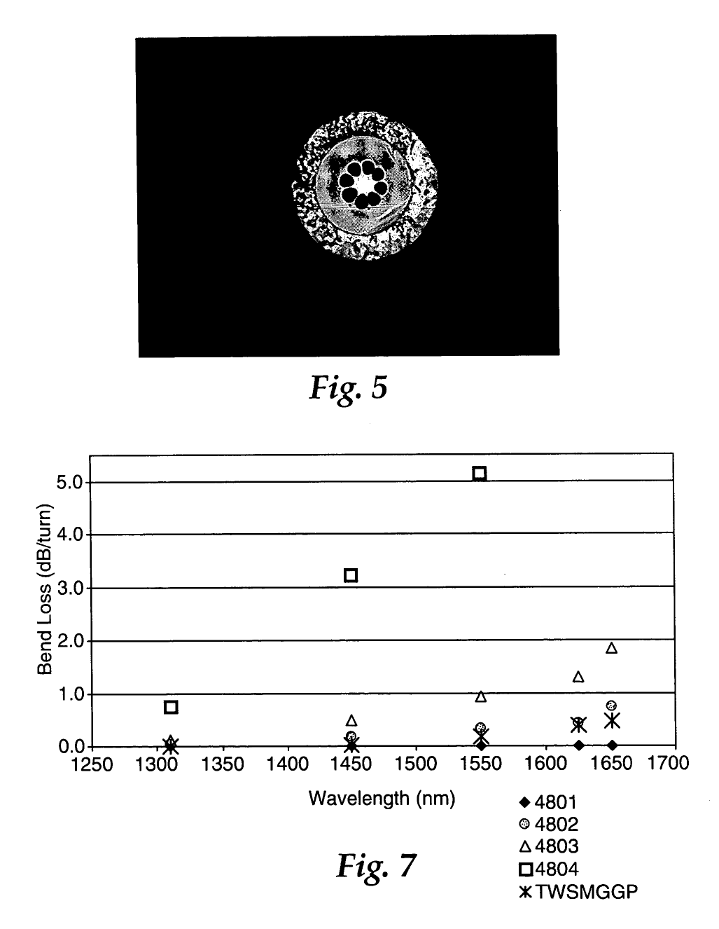

The preform was then stretched to 14.1 mm and finally overcollapsed an additional time with a 20 mm by 25 mm tube yielding a final diameter of 20.4 mm. After initial draws to this preform resulted in overcollapsed channels, a controlled pressure was applied to the channels during the draw. The draw yielded a hole assisted fiber, shown in FIG. 5, that included eight holes forming an inner ring, with an inner ring hole size of about 6 μm to 19 μm in diameter on a 125 μm fiber outer diameter. The outer ring holes are only faintly visible in FIG. 5, as they substantially precollapsed during the preform fabrication processes.

In a third example, another single mode preform was fabricated by conventional MCVD techniques. The finished diameter of the preform was 10.97 mm. Six slots of equal dimensions were ground into the preform by a conventional surface grinding machine and a conventional diamond impregnated grinding wheel. The grinding wheel thickness was 1.4 mm. During the grinding process, the preform was mechanically secured to the movable surface grinding table which was traversed continuously as the grinding wheel was slowly lowered to the specified slot depth (i.e., a conventional “plunge” grinding process). At the completion of the fabrication of one slot, the preform was rotated by 60 degrees and the process repeated to generate a second slot. This process was repeated until the desired six slots had been ground into the preform. The completed slots were 1.4 mm wide and had a depth of 3.1 mm.

The preform was chemically cleaned by conventional techniques. After cleaning, the preform was positioned in a conventional glassworking lathe. The lathe comprised a mechanism (holding clamp) for holding the preform and an overjacketing tube along the center of the lathe rotation, and a rotation mechanism to rotate the preform and overjacketing tube. A conventional oxyhydrogen torch whose temperature, position and traverse velocity could be controlled was fitted to the lathe carriage. For this example, the silica overjacketing tube had an outside diameter of 25 mm and an inside diameter of 19 mm and was collapsed onto the subject preform by conventional techniques using the hydrogen torch. At the completion of the overcollapse procedure, the preform diameter was 19.3 mm.

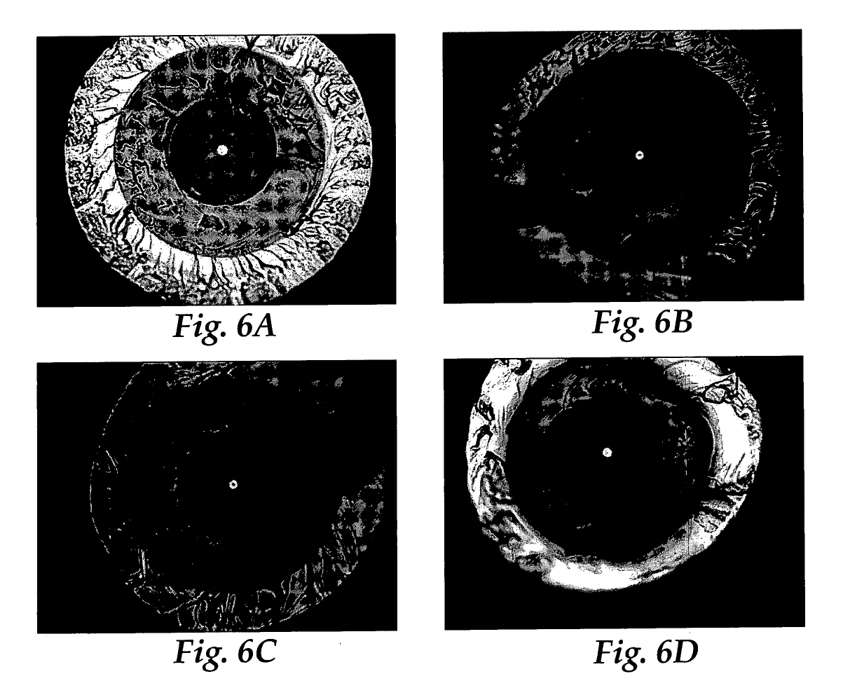

After completion of the preform fabrication process, the preform was drawn into optical fiber using a conventional optical fiber drawtower. The draw furnace temperature was 2075° C., and the draw speed was 60 meters/minute. The diameter of the drawn fiber was 80 μm and the fiber was coated with a conventional UV polymerized dual acrylate coating system. The coated diameter of the fiber was about 237 μm. During the draw process, a pressurization device, similar to that described above, was provided to apply pressurized nitrogen to the channels within the preform. The pressure was controlled to 2.5″ water (fiber D4801), 2.0″ water (fiber D4802), 1.0″ water (fiber D4803) and 0.0″ water (i.e., no measurable pressure) (fiber D4804) to produce four individual fibers, shown in cross section view in FIGS. 6A-6D.

As is evident from microphotographs of FIG. 6A-6D, the hole size in the fibers decreased with decreasing fiber pressure. Each of the fibers was optically characterized for single mode operation (cutoff wavelength), mode field diameter and attenuation, using conventional fiber characterization equipment and standard measurement procedures. Additionally, the macrobending induced attenuation was measured for the fibers when wrapped around a 10 mm diameter steel mandrel. As a comparison, a non-hole-assisted, single mode fiber (SMTWGGP) specially designed for good bend performance is also shown in Table 2. This comparative fiber was manufactured in accordance with the fibers and methods described in commonly pending, co-owned, U.S. patent application Ser. No. 10/930,575, incorporated by reference herein. Table 2 shows the results of this bend performance experiment. The bend performance measurements are also shown graphically in FIG. 7.

TABLE 2

| | | | | Macrobend |
|---|---|---|---|---|
| | Fiber Draw | Cutoff | Mode field | Attenuation |
| | Pressure | Wavelength | Diameter (μm) | Db/turn |
| Fiber ID | (in H₂O) | (nm) | 1330 nm | 1650 nm |
| D4801 | 2.5 | 1280 | 8.73 | 0 |
| D4802 | 2.0 | 1002 | 8.5 | 0.73 |
| D4803 | 1.0 | 985 | 8.1 | 1.85 |
| D4804 | 0.0 | 1380 | 8.99 | 20.58 |
| SMTWGGP | — | 1280 | 9.1 | 0.46 |

The results from Table 2 indicate that the presence of the holes in the fiber dramatically reduces the macrobend-induced attenuation. The macrobend attenuation results for the comparative single mode fiber optimized for minimum macrobend attenuation are also shown. The hole assisted fiber D4801 (with the largest hole size) compared favorably in macrobend performance with the comparative fiber.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

1. A hole-assisted fiber, comprising:
a core region; and
a cladding region, wherein the cladding region includes a plurality of non-circular holes, the plurality being four or more, symmetrically disposed about the core region and each spaced apart from each other in a first ring surrounding the core region, wherein the holes are filled with one of a gas and a liquid, and wherein a size of each of the non-circular holes is sufficient to provide the fiber with a bend loss of less than 1 dB per turn about a 10 mm diameter mandrel at 1550 nm.

2. The hole assisted fiber of claim 1, wherein the plurality of non-circular holes comprises a plurality of substantially elliptical holes.

3. The hole assisted fiber of claim 2, wherein the plurality of substantially elliptical holes comprises six or more holes symmetrically disposed about the core region and substantially equally spaced from the core in a radial direction.

4. The hole assisted fiber of claim 1, wherein the holes extend longitudinally along an entire length of the hole-assisted fiber.

5. The hole assisted fiber of claim 1, further comprising:
a permanent polymer based coating surrounding a perimeter of the cladding region.

6. The hole assisted fiber according to claim 1 having single mode operation.

7. The hole assisted fiber of claim 2, wherein the plurality of substantially elliptical holes comprises a first ring of substantially elliptical holes spaced at a first radial distance from the core region and a second ring of substantially elliptical holes spaced at a second radial distance from the core region, the second radial distance being different from the first radial distance.

8. The hole assisted fiber of claim 1, wherein an innermost edge of the plurality of holes is spaced at a distance of about 10 μm to about 25 μm from an outer diameter of the core region.

9. The hole assisted fiber of claim 1, wherein the core region comprises a doped silica material.

10. The hole assisted fiber of claim 1, wherein the core region further comprises a photosensitive material having a Bragg grating written in a portion thereof.

11. The hole-assisted fiber of claim 1, wherein at least one of the plurality of holes is filled with a liquid containing a biological material.

12. The hole assisted fiber of claim 1, wherein the plurality of holes are filled with air.

13-18. (canceled)

19. A hole-assisted fiber, comprising:
a core region; and
a cladding region, wherein the cladding region includes a single ring of four or more substantially elliptical holes symmetrically disposed about the core region, wherein the holes are filled with one of a gas and a liquid.

20. The hole assisted fiber of claim 19, wherein a size of each of the substantially elliptical holes is sufficient to provide the fiber with a bend loss of less than 1 dB per turn about a 10 mm diameter mandrel at 1550 nm.
